(19) United States
(12) Patent Application Publication
(10) Pub. No.: US 2005/0227057 A1
(43) Pub. Date: Oct. 13, 2005

(54) Method of manufacturing foamed composite

(76) Inventor: Dean Maxwell Voice, Greenbank (AU)

Correspondence Address: Jay S. Cinamon;Abelman Frayne & Schwab, 150 East 42nd Street, New York, NY, 10017, US

(21) Appl. No.: 10/509,560

(22) PCT Filed: Mar. 26, 2003
(86) PCT No.: PCT/AU03/00370

§ 371 Date: May 13, 2005

(30) Foreign Application Priority Data
Mar. 28, 2002 (AU) PS 1511

(51) Int. Cl. B29C 44/02

(52) U.S. Cl. 428/292.1; 264/51; 264/85

(57) ABSTRACT

A method of manufacturing a glass fibre reinforced structural composite article, said method comprising the steps of spraying a mechanically blended polyester foam into a mould whilst stimultaneously introducing chopped glass fibre. The mechanically blended polyester foam is foamed ulilising a gas, and said polyester foam includes a polyester resin that has a viscosity in the range of 12000-15000 cP (Brookfield LVT sp. 4/12 rpm). An article manufactured by this method can be made without the necessity of rolling to remove air bubbles, and has a density in the range of 0.6 to 0.8 g/cm³.

### TECHNICAL FIELD

The present invention relates to the manufacture of articles from glass fibre reinforced unsaturated polyester resins (GRP).

### BACKGROUND

A number of processes are used to manufacture articles from glass reinforced unsaturated polyester resins. Such articles include boats, swimming pools, spas, baths, shower stalls, washbasins, trailer panels, truck cabin components, coach/bus panels, water storage tanks and a wide variety of industrial chemical plant.

The simplest of these processes is the “hand lay-up” process that is the oldest and most labour intensive fabrication method. Hand lay-up is well suited for low volume production of articles. The hand lay-up process uses a room temperature cure system where catalysed resin is applied to the surface of a mould and fibreglass, usually veil, chopped mat or roving, is placed on top of the resin. The fibreglass is then saturated with the resin by rolling the surface with a roller. The rolling action assists in removal of air-bubbles that can detrimentally affect laminate performance. Subsequent to rolling, more resin and fibreglass is applied to the first layer. Each consecutive layer is applied the same as the first. Sometimes a final resin/wax topcoat is applied to the outer surface to prevent air inhibition and tackiness of the article.

A more commercially acceptable process is the faster “spray-up” process. A drawback of this process includes the possibility of air entrapment and difficulty in controlling variables such as the thickness and resin to glass ratio. The “spray-up” process is a room temperature cure process where continuous strand roving is fed through a chopper gun, combined with a catalysed resin, and sprayed onto a mould surface. The surface is then rolled to remove air bubbles. Additional layers of resin/glass are applied and rolled to reach the desired thickness. The composite produced by such a process has a density in excess of 1.6 g/cm³. Two known types of polyester resins which are conventionally used in the manufacture of baths, spas and other sanitary ware are those marketed by the Nuplex Industries (Aust) Pty Ltd as Polyplex 62363 and Polyplex 62365 that have a viscosity (in a liquid state at 25° C.) of 500-900 cP (Brookfield LVT sp 2/12 rpm). The composite articles produced with such resins include filler of up to 60% content such as calcium carbonate. This process typically utilises a catalyst such as MEKP of 0.75% to 3% volume of the resin/filler mix. A disadvantage of this method is that it is time consuming and labour intensive.

In recent times improvements in the spray up process have been achieved by the use of a “polyester foam unit” which allows for mechanically blended polyester foam to be applied to a mould without the requirement of rolling each layer to remove air bubbles. The Magnum Venus polyester foam unit, model No. MBF01, is a suitable unit that can generate foamed resins for use in glass fibre reinforced, no roll composite applications. The MBF01 polyester foam unit typically utilises Nitrogen and/or carbon dioxide as the foaming agent.

The present invention seeks to provide a method of manufacturing a glass fibre reinforced structural composite article which does not require rolling and which has a density significantly less than that of prior art articles and similar to non-glass reinforced mechanically blended foamed polyester resins also manufactured without the necessity of rolling.

### SUMMARY OF INVENTION

According to a first aspect the present invention consists in a method of manufacturing a glass fibre reinforced structural composite article, said method comprising the steps of spraying a mechanically blended polyester foam into a mould whilst simultaneously introducing chopped glass fibre, said mechanically blended polyester foam is foamed utilising a gas, characterised in that said polyester foam includes a polyester resin that has a viscosity in the range of 12000-15000 cP (Brookfield LVT sp. 4/12 rpm).

Preferably milled glass fibre is added to said polyester resin prior to said polyester resin being foamed and sprayed.

Preferably said milled glass fibre is added at 0-30% by weight.

Preferably said milled glass fibre is up to 2 mm in length.

Preferably said gas is nitrogen and/or carbon dioxide.

According to a second aspect the present invention consists in an article manufactured from a glass fibre reinforced structural composite utilising a spray up process without the necessity of rolling to remove air bubbles, said composite comprising a mechanically blended polyester foam characterised in that said composite has a density in the range of 0.6 to 0.8 g/cm³.

Preferably said polyester foam includes a polyester resin that has a viscosity in the range of 12000-15000 cP (Brookfield LVT sp. 4/12 rpm).

Preferably milled glass fibre is added to said polyester resin prior to said polyester resin being foamed and sprayed.

Preferably said milled glass fibre is added at 0-30% by weight.

Preferably said milled glass fibre is up to 2 mm in length.

### BRIEF DESCRIPTION OF THE DRAWING

FIG. 1 schematically depicts an embodiment of a “spray-up” arrangement that may be used to manufacture a glass reinforced structural composite article in accordance with the present invention.

### MODE OF CARRYING OUT INVENTION

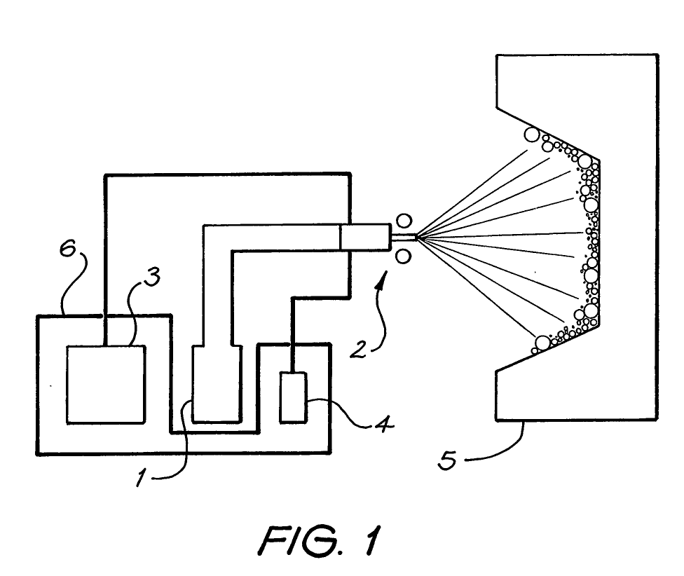

FIG. 1 depicts a “spray-up” process at a room temperature cure where continuous strand “glass fibre” roving 1 is passed through a chopper/spray gun 2, combined with a polyester resin 3, which is catalysed by means of a catalyst 4, and sprayed onto the surface of a mould 5.

In the present embodiment the polyester resin 3 and catalyst 4 is delivered to chopper/spray gun 2, by means of a foam unit 6. Preferably the foam unit to be used is a conventional Magnum Venus Mechanically Blended Polyester Foam Unit Model No. MBF01. The agent used to foam the polyester resin/catalyst mix is Nitrogen (N₂) gas and/or Carbon dioxide (CO₂) gas.

The resin/roving mixture is sprayed onto the mould 5 in a conventional manner to build up a laminate.

The polyester resin 3 preferably used has a viscosity in the range of 12000-15000 cP (Brookfield LVT sp. 4/12 rpm).

Where such a polyester resin is used, a glass reinforced structural composite article can be manufactured which does not require “filler”, nor does it require each successive layer of laminate to be rolled to remove bubbles and consolidate the laminate.

A composite article made in accordance with the present invention has a density of about 0.7 g/cm³, say in the range of 0.6-0.8 g/cm³, which is considerably less than that of a conventional article containing filler, which has a density of about 1.7-1.8 g/cm³.

Below is a table showing the comparable densities of an article made according to the embodiment of the present invention as compared to a prior art article made with a conventional resin marketed under the name Polyplex 62365, incorporating filler material and glass fibre reinforcement.

| | | Density of article | Density of prior art |
|---|---|---|---|
| | | in accordance with | Polyplex 62365 |
| Thickness | Glass | present embodiment | article |
| (mm) | % w/w | g/cm³ | g/cm³ |
| 3 | 18 | 0.67 | 1.76 |
| 3 | 22 | 0.70 | 1.78 |
| 4 | 18 | 0.67 | 1.76 |
| 4 | 22 | 0.70 | 1.78 |
| 5 | 18 | 0.67 | 1.76 |
| 5 | 22 | 0.70 | 1.78 |
| 6 | 18 | 0.67 | 1.76 |
| 6 | 22 | 0.70 | 1.78 |

An advantage of the present embodiment, is that articles from glass reinforced unsaturated polyester resins can be manufactured which are strong, but are considerably lighter with significantly lower labour and raw material costs as well as reduced fume emissions. As no filler may be used, the step of mixing and introducing filler may be eliminated.

Additionally, in carrying out the above described “spray-up” process, it is possible to add milled glass fibre to the polyester resin prior to the polyester resin being foamed. Preferably the milled glass fibre is added at 0-30% weight, and preferably the milled glass fibre has a length of about 0.8 mm, but can be in the range of 0.5-2 mm. When adding milled glass fibre to the polyester resin prior to foaming, the amount of chopped glass fibre being added at the spray gun is preferably reduced in an equivalent amount to that being added as milled glass fibre. An advantage of adding milled glass fibre prior to the polyester resin being foamed and sprayed, is that a more uniform distribution of glass fibre occurs in the article being manufactured.

Whilst in the above referenced embodiment nitrogen is preferably used as a foaming agent, it has been found carbon dioxide can be used as a foaming agent having similar advantages as that as using nitrogen. However, foam produced using carbon dioxide, generally has a coarser structure. It should be understood that in other embodiments other suitable gases and combinations of gases may be used as the foaming agent.

The term “comprising” as used herein is used in the inclusive sense of “including” or “having” and not in the exclusive sense of “consisting only of”.

1. A method of manufacturing a glass fibre reinforced structural composite article, said method comprising the steps of spraying a mechanically blended polyester foam into a mould whilst simultaneously introducing chopped glass fibre, said mechanically blended polyester foam is foamed utilising a gas, characterised in that said polyester foam includes a polyester resin that has a viscosity in the range of 12000-15000 cP (Brookfield LVT sp. 4/12 rpm).

2. A method of manufacturing a glass fibre reinforced structural composite article as claimed in claim 1, wherein milled glass fibre is added to said polyester resin prior to said polyester resin being foamed and sprayed.

3. A method of manufacturing a glass fibre reinforced structural composite article as claimed in claim 2, wherein said milled glass fibre is added at 0-30% by weight.

4. A method of manufacturing a glass fibre reinforced structural composite article as claimed in claim 2, wherein said milled glass fibre is up to 2 mm in length.

5. A method of manufacturing a glass fibre reinforced structural composite article as claimed in claim 1, wherein said gas is nitrogen, carbon dioxide, or mixtures thereof.

6. An article manufactured in accordance with claim 1, wherein said composite has a density in the range of 0.6 to 0.8 g/cm³.

7-10. (canceled)
